(19) United States
(12) Patent Application Publication
(10) Pub. No.: US 2025/0201457 A1
(43) Pub. Date: Jun. 19, 2025

(54) Sm-Fe-N-BASED MAGNETIC MATERIAL AND PRODUCTION METHOD THEREOF

(71) Applicants: TOYOTA JIDOSHA KABUSHIKI KAISHA, Toyota-shi (JP); THE UNIVERSITY OF TOKYO, Tokyo (JP); NATIONAL INSTITUTE OF ADVANCED INDUSTRIAL SCIENCE AND TECHNOLOGY, Tokyo (JP)

(72) Inventors: Tetsuya SHOJI, Susono-shi (JP); Noritsugu SAKUMA, Mishima-shi (JP); Akihito KINOSHITA, Mishima-shi (JP); Tetsuya FUKUSHIMA, Tokyo-to (JP); Hisazumi AKAI, Tokyo-to (JP); Haruki OKUMURA, Tokyo-to (JP); Masahiro SAKURAI, Tokyo-to (JP); Takashi MIYAKE, Tsukuba-shi (JP); Taro FUKAZAWA, Tsukuba-shi (JP); Keiichi TAMAI, Tsukuba-shi (JP)

(73) Assignees: TOYOTA JIDOSHA KABUSHIKI KAISHA, Toyota-shi (JP); THE UNIVERSITY OF TOKYO, Tokyo (JP); NATIONAL INSTITUTE OF ADVANCED INDUSTRIAL SCIENCE AND TECHNOLOGY, Tokyo (JP)

(21) Appl. No.: 18/921,714

(22) Filed: Oct. 21, 2024

(30) Foreign Application Priority Data
Dec. 19, 2023 (JP) 2023-213937

(51) Int. Cl. H01F 1/059; H01F 1/055

(52) U.S. Cl. CPC H01F 1/0593; H01F 1/0558; H01F 1/0596

(57) ABSTRACT

A Sm—Fe—N-based magnetic material in which the use amount of Sm is further reduced while enhancing the saturation magnetization, and a production method thereof, are provided. The present disclosure discloses a Sm—Fe—N-based magnetic material including a main phase having a crystal structure of at least either Th₂Zn₁₇ type or Th₂Ni₁₇ type, wherein the main phase is represented by the molar ratio formula (Sm_{(1-x-y-z)}LaₓCe_{y}R¹_{z})₂(Fe_{(1-p-q-s)}CoₚNi_{q}Mₛ)₁₇Nₕ, where R¹ is one or more rare earth elements other than Sm, La and Ce, and Zr, and M is one or more elements other than Fe, Co, Ni and rare earth elements, and an unavoidable impurity element, and 0.09≤x≤0.31, 0.24≤y≤0.60, 0.51≤x+y≤0.75, 0≤z≤0.10, 0≤p+q≤0.10, 0≤s≤0.10, and 2.9≤h≤3.1 are satisfied, and a production method thereof.

### TECHNICAL FIELD

The present disclosure relates to a Sm—Fe—N-based magnetic material and a production method thereof. More specifically, the present disclosure relates to a Sm—Fe—N-based magnetic material including a main phase having a crystal structure of at least either Th₂Zn₁₇ type or Th₂Ni₁₇ type, and a production method thereof.

### BACKGROUND

As a high-performance magnetic material, a Sm—Co-based magnetic material and a Nd—Fe—B-based magnetic material have been put into practical use, but recently, magnetic materials other than these have been studied. For example, a Sm—Fe—N-based magnetic material including a main phase having a crystal structure of at least either Th₂Zn₁₇ type or Th₂Ni₁₇ type (hereinafter, sometimes simply referred to as “Sm—Fe—N-based magnetic material”) is being studied.

The Sm—Fe—N-based magnetic material includes a main phase having a crystal structure of at least either Th₂Zn₁₇ type or Th₂Ni₁₇ type. In this main phase, nitrogen is considered to be interstitially incorporated into a Sm—Fe-based crystal phase. For such a main phase, Sm is indispensable, but due to low reserves of Sm, the price of Sm is expected to rise sharply as the Sm—Fe—N-based magnetic material becomes widespread. Therefore, attempts have heretofore been made to reduce the use amount of Sm.

For example, PTL 1 discloses a Sm—Fe—N-based magnetic material in which part of Sm is substituted by inexpensive La and/or Ce.

### CITATION LIST

### Patent Literature

PTL 1 JP2022-53187A

### SUMMARY

### Technical Problem

In the Sm—Fe—N-based magnetic material disclosed in PTL 1, the percentage of substitution of La and/or Ce is at most 50%, and more reduction in the use amount of Sm is being desired.

An object of the present disclosure is to provide a Sm—Fe—N-based magnetic material in which the use amount of Sm is further reduced while enhancing the saturation magnetization, and a production method thereof.

### Solution to Problem

The present disclosers have made many intensive studies to attain the object above and have accomplished the Sm—Fe—N-based magnetic material of the present disclosure and a production method thereof. The Sm—Fe—N-based magnetic material of the present disclosure and a production method thereof include the following embodiments.

<1> A Sm—Fe—N-based magnetic material including a main phase having a crystal structure of at least either Th₂Zn₁₇ type or Th₂Ni₁₇ type, wherein
the main phase is represented by the molar ratio formula (Sm_{(1-x-y-z)}LaₓCe_{y}R¹_{z})₂(Fe_{(1-p-q-s)}CoₚNi_{q}Mₛ)₁₇Nₕ, where R¹ is one or more rare earth elements other than Sm, La and Ce, and Zr, and M is one or more elements other than Fe, Co, Ni and rare earth elements, and an unavoidable impurity element, and

$$0.09 \leq x \leq 0.31 , \\ 0.24 \leq y \leq 0.6 , \\ 0.51 \leq x + y \leq 0.75 , \\ 0 \leq z \leq 0.1 , \\ 0 \leq p + q \leq 0.1 , \\ 0 \leq s \leq 0.1 , and \\ 2.9 \leq h \leq 3.1 are satisfied .$$

<2> The Sm—Fe—N-based magnetic material according to item <1>, wherein x and y satisfy 0.16≤x≤0.31 and 0.24≤y≤0.45.

<3> The Sm—Fe—N-based magnetic material according to item <1> or <2>, wherein the volume fraction of the main phase is 80% or more and 100% or less.

<4> A production method of the Sm—Fe—N-based magnetic material according to item <1>, the Sm—Fe—N-based magnetic material production method including:
preparing a magnetic material precursor including a crystal phase having a composition represented by the molar ratio formula (Sm_{(1-x-y-z)}LaₓCe_{y}R¹_{z})₂(Fe_{(1-p-q-s)}CoₚNi_{q}Mₛ)₁₇, where R¹ is one or more rare earth elements other than Sm, La and Ce, and Zr, and M is one or more elements other than Fe, Co, Ni and rare earth elements, and an unavoidable impurity element, in which 0.09≤x≤0.31, 0.24≤y≤0.60, 0.51≤x+y≤0.75, 0≤z≤0.10, 0≤p+q≤0.10, and 0≤s≤0.10 are satisfied, and
nitriding the magnetic material precursor.

<5> The Sm—Fe—N-based magnetic material production method according to item <4>, wherein x and y satisfy 0.16≤x≤0.31 and 0.24≤y≤0.45.

### Advantageous Effects of Invention

According to the present disclosure, a Sm—Fe—N-based magnetic material and a production method thereof where the molar ratios of Sm, La and Ce are optimized and the use amount of Sm is thereby more reduced than ever before while enhancing the saturation magnetization, can be provided.

### BRIEF DESCRIPTION OF DRAWINGS

FIG. 1 is a formation energy map where the molar ratios of three elements Sm, La and Ce in Examples 1 to 6 and Comparative Examples 1 to 11 are plotted on the results obtained by determining, through numerical calculation, the relationship between the molar ratios of three elements Sm, La and Ce and the formation energy.

FIG. 2 is a saturation magnetization map where the molar ratios of three elements Sm, La and Ce in Examples 1 to 6 and Comparative Examples 1 to 11 are plotted on the results obtained by determining, through numerical calculation, the relationship between the molar ratios of three elements Sm, La and Ce and the saturation magnetization.

### DESCRIPTION OF EMBODIMENTS

Embodiments of the Sm—Fe—N-based magnetic material of the present disclosure (hereinafter, sometimes simply referred to as “magnetic material of the present disclosure”) and the production method thereof are described in detail below. Note that the embodiments described below do not limit the magnetic material of the present disclosure and the production method thereof.

Although not bound by theory, the knowledge obtained by the present disclosers about the reason why the use amount of Sm is more reduced than ever before while enhancing the saturation magnetization is described below.

As the element substituted for Sm in the main phase, conventionally, La has been used. Compared with Sm, the ionic radius of La is very large and therefore, when Sm in the main phase is substituted by a large amount of La, it becomes difficult for the main phase to maintain a crystal structure of at least either Th₂Zn₁₇ type or Th₂Ni₁₇ type. On the other hand, the ionic radius of Ce is slightly large in comparison to Sm and consequently, compared with La, Sm in the main phase can be substituted by a large amount of Ce. However, if its substitution amount is very large, it becomes difficult for the main phase to maintain a crystal structure of at least either Th₂Zn₁₇ type or Th₂Ni₁₇ type. In addition, even when the main phase can maintain a crystal structure of at least either Th₂Zn₁₇ type or Th₂Ni₁₇ type, if its substitution amount is large, the saturation magnetization greatly decreases.

Therefore, in the case where nitrogen has intruded into a crystal phase having a crystal structure of at least either Th₂Zn₁₇ type or Th₂Ni₁₇ type, the influence of molar ratios of three elements Sm, La and Ce on the stability and saturation magnetization of the crystal phase has been closely examined.

Specifically, how the formation energy of (Sm, La, Ce)₂Fe₁₇N₃ phase changes depending on the molar ratios of Sm, La and Ce in the (Sm, La, Ce)₂Fe₁₇N₃ phase is calculated using a first-principles calculation. Then, with respect to the formation energy, a formation energy map showing the relationship between the molar ratios of three elements Sm, La and Ce and the formation energy is created using a regular solution approximation. In addition, structural parameters based on lattice constant are calculated using a first-principles calculation, and from the structural parameters, a saturation magnetization map is generated using a regular solution approximation formula. As a result, the present disclosers have found that a Sm—Fe—N-based magnetic material where the use amount of Sm is more reduced than ever before while enhancing the saturation magnetization is obtained by optimizing the molar ratios of Sm, La and Ce.

The constituent elements of the magnetic material of the present disclosure and the production method thereof, which have been accomplished based on the above-described findings, etc., are described below.

### <<Magnetic Material>>

The magnetic material of the present disclosure includes a main phase having a crystal structure of at least either Th₂Zn₁₇ type or Th₂Ni₁₇ type. The magnetic material of the present disclosure develops magnetism due to the main phase. The main phase is described below.

### <Crystal Structure of Main Phase>

The main phase has a crystal structure of at least either Th₂Zn₁₇ type or Th₂Ni₁₇ type. The crystal structure of the main phase may include a TbCu₇-type crystal structure, etc., in addition to the structures described above. Here, Th is thorium, Zn is zinc, Ni is nickel, Tb is terbium, and Cu is copper. The crystal structure of the main phase can be identified by subjecting the magnetic material of the present disclosure, for example, to an X-ray diffraction analysis, etc.

The phase having the above-described crystal structure can be achieved by a combination (composition) of various elements, but the main phase in the magnetic material of the present disclosure is achieved by a combination (composition) of the following elements. The composition of the main phase in the magnetic material of the present disclosure is described below.

### <Composition of Main Phase>

The main phase has a composition represented by the molar ratio formula (Sm_{(1-x-y-z)}LaₓCe_{y}R¹_{z})₂(Fe_{(1-p-q-s)}CoₚNi_{q}Mₛ)₁₇Nₕ. In the composition formula above, Sm is samarium, La is lanthanum, Ce is cerium, Fe is iron, Co is cobalt, and Ni is nickel. R¹ is one or more rare earth elements other than Sm, La and Ce, and Zr, and M is one or more elements other than Fe, Co, Ni and rare earth elements, and an unavoidable impurity element. Here, Zr is zirconium. Also, in the formula above, for convenience of description, Sm_{(1-x-y)}LaₓCe_{y}R¹_{z} and Fe_{(1-p-q-s)}CoₚNi_{q}Mₛ are sometimes referred to as a rare earth site and an iron group site, respectively.

As can be understood from the formula above, the main phase contains 2 mols of one or more elements of the rare earth site, 17 mols of one or more elements of the iron group site, and h mols of nitrogen (N). More specifically, the phase having the above-described crystal structure is constituted by one or more elements of the rare earth site and one or more elements of the iron group site, and h mols of nitrogen (N) is interstitially incorporated into the phase. The amount of nitrogen (N) incorporated is typically 3 mols, i.e., h=3, but there may partially be a part where nitrogen is not incorporated, and as long as it is h mols (provided that h is from 2.9 to 3.1), the crystal structure described above can be maintained. Details of nitrogen (N) in the main phase are described later.

The rare earth site consists of Sm, La, Ce and R¹, and Sm, La, Ce and R¹ are present at a ratio of (1−x−y−z):x:y:z in terms of molar ratio. Since (1−x−y−z)+x+y+z=1, the ratio means that part of Sm is substituted by one or more elements selected from the group consisting of La, Ce and R¹.

The iron group site consists of Fe, Co, Ni and M, and Fe, Co, Ni and M are present at a ratio of (1−p−q−s):p:q:s in terms of the molar ratio. Since (1−p−q−s)+p+q+s=1, the ratio means that part of Fe is substituted by one or more elements selected from the group consisting of Co, Ni and M.

Each element constituting the formula above and the content ratio (molar ratio) thereof are described below.

### <Sm>

Sm is a main element constituting the above-described crystal structure together with Fe and N. Part of Sm is substituted by one or more elements selected from the group consisting of La, Ce and Rt. La, Ce and R are described below.

### <La>

La belongs to the so-called light rare earth elements and, compared with Sm, is abundant in reserve (resource amount) and inexpensive. In addition, this is considered to contribute to enhancing the saturation magnetization. However, since the ionic radius of La is greatly larger than the ionic radius of Sm, unless the substitution amount is appropriately set at the time of substituting part of Sm by La, it becomes difficult for the main phase to maintain the crystal structure. The substitution amount is described later.

### <Ce>

Ce belongs to the so-called light rare earth elements and, compared with Sm, is abundant in reserve (resource amount) and inexpensive. Since the ionic radius of Ce is slightly larger than the ionic radius of Sm, part of Sm can be substituted by a large amount of Ce. However, if its substitution amount is very large, it becomes difficult for the main phase to maintain the crystal structure. Also, even when the crystal structure of the main phase can be maintained, if the substitution amount is large, the saturation magnetization greatly decreases. The substitution amount is described later.

<R¹>

R¹ is one or more rare earth elements other than Sm, La and Ce, and Zr. R¹ is one or more elements that the magnetic material of the present disclosure is allowed to contain within a range not impairing its magnetic properties. The allowable amount is described later. R is typically one or more rare earth elements other than Sm, La and Ce, which are difficult to completely separate from each of Sm, La and Ce when purifying respective raw materials containing these elements and remain in a small amount in the raw material, etc. In addition to such rare earth elements, R¹ may contain Zr. Zr is not a rare earth element, but part of Sm is sometimes substituted by Zr. Even when part of Sm is substituted by Zr, as long as its substitution amount is small, the magnetic properties of the magnetic material of the present disclosure are not significantly impaired.

In the present description, the rare earth elements include 17 elements of Sc (scandium), Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium) and Lu (ruthenium).

### <Fe>

Fe is a main element constituting the above-described crystal structure together with Sm and N. Part of Fe may be substituted by one or more elements selected from the group consisting of Co, Ni and M. Co, Ni and M are described below.

### <Co>

Co belongs to the so-called iron group elements, and therefore part of Fe may be substituted by Co. As long as the substitution amount is in a predetermined range, the substitution does not have such an effect on the formation energy of the main phase as to pose a problem in practical use. The allowable amount is described later. When part of Fe is substituted by Co, this is advantageous in that the Curie temperature of the main phase rises and a decrease in the saturation magnetization at a high temperature (from 403 to 473 K) can be suppressed.

### <Ni>

Ni belongs to the so-called iron group elements and, therefore, part of Fe may be substituted by Ni. As long as the substitution amount is in a predetermined range, the substitution does not have such an effect on the formation energy of the main phase as to pose a problem in practical use. The allowable amount is described later.

### <M>

M is one or more elements other than Fe, Co, Ni and rare earth elements, and an unavoidable impurity element. M is one or more elements and an unavoidable impurity element, which the magnetic material of the present disclosure is allowed to contain within a range not impairing its magnetic properties. The unavoidable impurity element refers to an impurity element that is inevitably included at the time of production, etc. of the magnetic material of the present disclosure or causes a significant rise in the production cost for avoiding its inclusion. Such an unavoidable impurity element includes impurity elements in raw materials, or elements, for example, an element included in a bond and undergoes diffusion and/or intrusion, etc. into the surface, etc. of the main phase at the time of forming, etc. of a bonded molded body, such as Cu (copper), Zn (zinc), Ga (gallium), Al (aluminum) and B (boron). In addition, the unavoidable elements include elements contained in a lubricant, etc. used at the time of molding, which are an element having diffused and/or intruded into the surface, etc. of the main phase. Here, the bonded molded body is described later.

M excluding the unavoidable impurity element includes, for example, one or more elements selected from the group consisting of Ti (titanium), Cr (chromium), Mn (manganese), V (vanadium), Mo (molybdenum), W (tungsten) and C (carbon). These elements form, for example, a nuclear material at the time of producing the main phase and thereby contribute to promoting miniaturization of the main phase and/or suppressing grain growth of the main phase.

Furthermore, Zr may be contained as M. As described above, Zr is not a rare earth element, but part of Sm is substituted by Zr in some cases and on the other hand, part of Fe is substituted by Zr in some cases. In either case, as long as the substitution amount is small, the magnetic properties of the magnetic material are not significantly impaired.

### <N>

N is interstitially incorporated into the main phase having the above-described crystal structure. N is incorporated to such an extent that N does not break the phase having the above-described crystal structure, and a magnetic moment thereby increases in the main phase. The abundance ratio (molar ratio) h of N in the main phase is described later.

When the main phase of the magnetic material of the present disclosure is constituted by the hereinbefore-described elements and these elements are present in the following ratios, the use amount of Sm can be more reduced than ever before while enhancing the saturation magnetization. In the following, the abundance ratios (molar ratios) of constituent elements, namely, the ranges satisfying the values of x, y, z, p, q, s and h in the formula above representing the composition of the main phase, are described.

<x, y and z>

The stability of the main phase can be evaluated by the formation energy of the main phase. For this evaluation, a formation energy map showing the relationship between the molar ratios of three elements Sm, La and Ce and the formation energy is created.

As for the method of first-principles calculation, a package (AkaiKKR) using Korringa-Kohn-Rostoker (KKR) Coherent Potential Approximation (CPA) and a Vienna ab initio simulation package (VASP) are used. Specifically, with respect to a total of 52 points generated by increasing each of x and y of (Sm_{(1-x-y)}LaₓCe_{y})₂Fe₁₇N₃ phase in steps of 5%, the formation energy is calculated at respective points.

From the calculation results at the above-described 52 points, a formation map is generated using a regular solution approximation formula. The regular solution approximation formula is as follows.

$$Δ E ( x , y ) = {E}_{RFN ( x , y )} - ( 1 - x - y ) {E}_{SFN} - {xE}_{LFN} - {yE}_{CFN}$$

Here, ΔE(x, y), E_{RFN(x, y)}, E_{SFN}, E_{LFN}, and E_{CFN} are as follows:
ΔE(x, y): a formation energy change when the molar ratios of La and Ce are x and y,
E_{RFN}(x, y): a total energy of AkaiKKR when the molar ratios of La and Ce are x and y,
E_{SFN}: a value obtained by correcting the total energy of AkaiKKR of Sm₂Fe₁₇N₃ with a formation enthalpy of VASP,
E_{LFN}: a value obtained by correcting the total energy of AkaiKKR of La₂Fe₁₇N₃ with a formation enthalpy of VASP, and
E_{CFN}: a value obtained by correcting the total energy of AkaiKKR of Ce₂Fe₁₇N₃ with a formation enthalpy of VASP.

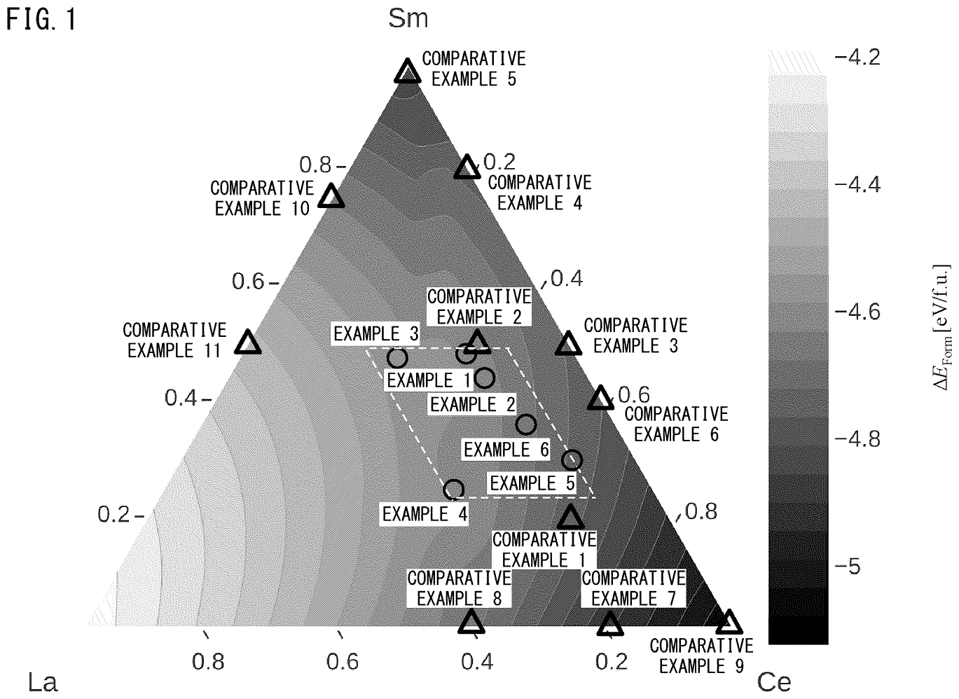

FIG. 1 is a formation energy map showing the relationship between the molar ratios of three elements Sm, La and Ce and the formation energy. In FIG. 1, the molar ratios of three elements Sm, La and Ce in later-described Examples 1 to 6 and Comparative Examples 1 to 11 are shown together (plotted).

In the formation energy map, the (Sm_{(1-x-y)}LaₓCe_{y})₂Fe₁₇N₃ phase is stabilized in a small formation energy region. Fundamentally, as the substitution amount of La, i.e., the value of x, is increased, the (Sm_{(1-x-y)}LaₓCe_{y})₂Fe₁₇N₃ phase becomes unstable. The formation energy map reveals that the formation energy is lower, namely, the (Sm_{(1-x-y)}LaₓCe_{y})₂Fe₁₇N₃ phase is more stable when substituted by both La and Ce at the time of substituting part of Sm by La or Ce than when substituted only by La.

The Ce₂Fe₁₇N₃ phase is more stable than Sm₂Fe₁₇N₃ phase, but in the case where a phase more stable than Ce₂Fe₁₇N₃ phase, for example, CeFe₂ phase, has already been produced, it is difficult to produce Ce₂Fe₁₇N₃ phase, requiring consideration of convex hull. Therefore, in FIG. 1, the molar ratios of three elements Sm, La and Ce in later-described Examples 1 to 6 and Comparative Examples 1 to 11 are shown together (plotted).

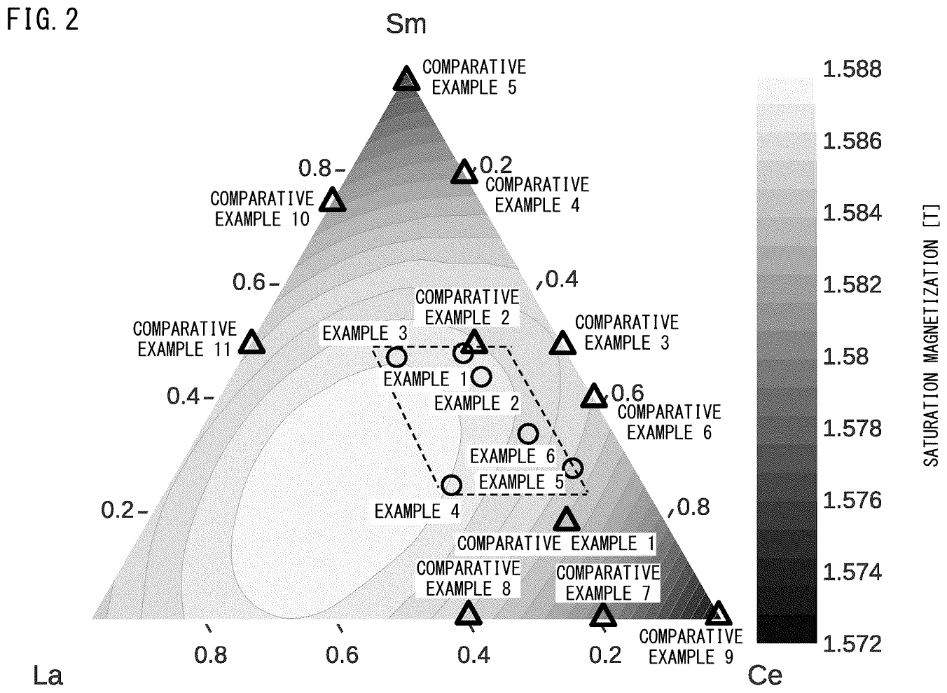

In addition, structural parameters based on lattice constant are calculated using a first-principles calculation. The structural parameters are an interatomic distance, etc. of the atoms constituting the (Sm_{(1-x-y)}LaₓCe_{y})₂Fe₁₇N₃ phase. As for the method of first-principles calculation, VASP is used. To a solid solution phase, the Vegard's law is applied. Then, from the obtained structural parameters, a saturation magnetization map is generated using AkaiKKR. FIG. 2 is a saturation magnetization map showing the relationship between the molar ratios of three elements Sm, La and Ce and the saturation magnetization. In FIG. 2, the molar ratios of three elements Sm, La and Ce in later-described Examples 1 to 6 and Comparative Examples 1 to 11 are shown together (plotted).

The formation energy is related to stability of the (Sm_{(1-x-y)}LaₓCe_{y})₂Fe₁₇N₃ phase, and the total magnetic moment is proportional to the magnetization. Therefore, the relationship between the stability of (Sm_{(1-x-y)}LaₓCe_{y})₂Fe₁₇N₃ phase and the saturation magnetization can be studied using the formation energy map and the saturation magnetization map. These maps reveal that the saturation magnetization as well as the stability are more enhanced when substituted by both La and Ce at the time of substituting part of Sm by La or Ce than when substituted only by La. Although not bound by theory, the reason why the saturation magnetization is enhanced is considered to be as follows. Ce exists in the trivalent or tetravalent state and, in the magnetic material of the present disclosure, tetravalent Ce exists in large numbers. On the other hand, La exists only in the trivalent state. In the tetravalent state, 4f electrons are not allowed to localize and consequently, magnetization is likely to disappear, but since La exists in the trivalent state, allowing 4f electrons to localize, magnetization is considered to be enhanced by La.

As seen in those described hereinbefore, particularly, in the depictions in FIGS. 1 and 2, x may be 0.09 or more, 0.10 or more, 0.12 or more, 0.14 or more, or 0.16 or more, and may be 0.31 or less, 0.30 or less, 0.27 or less, 0.25 or less, 0.23 or less, 0.20 or less, or 0.17 or less.

Also, y may be 0.24 or more, 0.26 or more, 0.30 or more, 0.32 or more, or 0.34 or more, and may be 0.60 or less, 0.55 or less, 0.50 or less, 0.45 or less, or 0.40 or less.

Furthermore, x+y may be 0.51 or more, 0.54 or more, 0.56 or more, or 0.60 or more, and may be 0.75 or less, 0.70 or less, or 0.69 or less.

As described above, R¹ is one or more elements that the magnetic material of the present disclosure is allowed to contain within a range not impairing its magnetic properties, and therefore, in the first-principles calculation, the presence of R is not taken into consideration. The molar ratio of such R¹, i.e., the range of z, may be 0.10 or less, 0.08 or less, 0.06 or less, 0.04 or less, or 0.02 or less. The magnetic material of the present disclosure may not contain R¹ at all, i.e., z may be 0, but it is sometimes difficult to make R¹ to be not contained at all in raw materials at the time of producing the magnetic material of the present disclosure. From this viewpoint, z may be 0.01 or more.

<p and q>

In the formula above representing the composition of the main phase, the value of p indicates the ratio (molar ratio) in which part of Fe is substituted by Co, and the value of q indicates the ratio (molar ratio) in which part of Fe is substituted by Ni.

As described above, Co and Ni are elements which are allowed to be contained within a range not having such an effect on the formation energy of the main phase as to pose a problem in practical use. This allowable range is expressed using the value of a total p+q of the molar ratio p of Co and the molar ratio q of Ni. The value of p+q may be 0.10 or less, 0.09 or less, 0.08 or less, 0.07 or less, 0.06 or less, or 0.05 or less, and may be 0 or more, 0.01 or more, 0.02 or more, 0.03 or more, or 0.04 or more. The value of p+q being 0 means that the main phase is substantially free from Co and Ni.

<s>

In the formula above representing the composition of the main phase, s indicates the ratio (molar ratio) in which part of Fe is substituted by M. As described above, M is one or more elements and an unavoidable impurity element, which the magnetic material of the present disclosure is allowed to contain within a range not impairing its magnetic properties. Accordingly, s may be 0.10 or less, 0.08 or less, 0.06 or less, 0.04 or less, or 0.02 or less. On the other hand, although the magnetic material of the present disclosure may not contain M at all, i.e. s may be 0, it is sometimes difficult to make, out of M, an impurity element to be not contained at all. From this viewpoint, s may be 0.01 or more.

<h>

In the formula above representing the composition of the main phase, h indicates the degree of nitriding. When a Sm₂Fe₁₇ phase is nitrided, basically, a Sm₂Fe₁₇Nₕ phase (where, h=3) is formed. Nitriding is typically performed by exposing a magnetic material precursor (hereinafter, sometimes simply referred to as “precursor”) having a Sm₂Fe₁₇ phase to a nitrogen gas atmosphere at a high temperature. Consequently, for example, the condition of nitriding differs between the surface and the inside of the precursor and, therefore, h can fluctuate in a range of 2.9 to 3.1. The same applies to the case where in the precursor, part of Sm is substituted by La, Ce and/or R and part of Fe is substituted by Co, Ni and/or M. More specifically, when a (Sm_{(1-x-y-z)}LaₓCe_{y}R¹_{z})₂(Fe_{(1-p-q-s)}CoₚNi_{q}Mₛ)₁₇ phase is nitrided, (Sm_{(1-x-y-z)}LaₓCe_{y}R¹_{z})₂(Fe_{(1-p-q-s)}CoₚNi_{q}Mₛ)₁₇Nₕ is formed.

### <Volume Fraction>

The magnetic material of the present disclosure includes a main phase represented by the composition formula described above. The magnetic properties of the magnetic material of the present disclosure are developed by the main phase. Therefore, the volume fraction of the main phase is preferably higher relative to the entire magnetic material of the present disclosure. Specifically, the volume fraction of the main phase may be, relative to the entire magnetic material of the present disclosure, 80% or more, 85% or more, or 90% or more. On the other hand, the production of the magnetic material of the present disclosure sometimes involves, for example, a step of entering a temperature range where a phase other than the main phase represented by the composition formula above is stable. Also, it is sometimes difficult to be completely free from unavoidable impurity elements not constituting the main phase. From these points of view, although the volume fraction of the main phase is ideally 100%, as long as the above-described volume fraction of the main phase is ensured, there is no problem in practical use even when the volume fraction of the main phase is 99% or less, 97% or less, or 95% or less.

The phase other than the main phase is typically present at grain boundaries between main phases, particularly at a triple point. The phase other than the main phase typically includes a SmFe₃ phase and its nitride phase, etc. The SmFe₃ phase and its nitride phase include a phase in which part of Sm is substituted by one or more elements selected from the group consisting of La, Ce and R¹, and its nitride phase; a phase in which part of Fe is substituted by one or more elements selected from the group consisting of Co, Ni and M, and its nitride phase; and a phase in which part of Sm is substituted by one or more elements selected from the group consisting of La, Ce and R¹ and part of Fe is substituted by one or more elements selected from the group consisting of Co, Ni and M, and their nitride phase.

As for the volume fraction of the main phase, the overall composition of the magnetic material precursor before nitriding is measured using Inductively Coupled Plasma Atomic Emission Spectroscopy (ICP-AES) and, on the assumption that the precursor before nitriding is divided into a (Sm, La, Ce, R¹)₂(Fe, Co, Ni, M)₁₇ phase and a (Sm, La, Ce, R¹)(Fe, Co, Ni, M)₃ phase, the volume fraction of the main phase is calculated based on the measured values. Specifically, after a mass concentration (mass fraction) of each element is obtained from the ICP measurement results, a mass ratio of Sm₂Fe₁₇ phase and SmFe₃ phase is first calculated, and the volume fraction is calculated from the density of each phase. Note that the (Sm, La, Ce, R¹)₂(Fe, Co, Ni, M)₁₇ phase represents a Sm₂Fe₁₇ phase, a phase in which part of Sm in the Sm₂Fe₁₇ phase is substituted by one or more elements selected from the group consisting of Sm, La, Ce and R¹, a phase in which part of Fe in the Sm₂Fe₁₇ phase is substituted by one or more elements selected from the group consisting of Co, Ni and M, and a phase in which part of Sm in the Sm₂Fe₁₇ phase is substituted by one or more elements selected from the group consisting of Sm, La, Ce and R and part of Fe in the Sm₂Fe₁₇ phase is substituted by one or more elements selected from the group consisting of Co, Ni and M. Furthermore, the (Sm, La, Ce, R¹)(Fe, Co, Ni, M)₃ phase represents a SmFe₃ phase, a phase in which part of Sm in the SmFe₃ phase is substituted by one or more elements selected from the group consisting of Sm, La, Ce and R¹, a phase in which part of Fe in the SmFe₃ phase is substituted by one or more elements selected from the group consisting of Co, Ni and M, and a phase in which part of Sm in the SmFe₃ phase is substituted by one or more elements selected from the group consisting of Sm, La, Ce and R¹ and part of Fe in the SmFe₃ phase is substituted by one or more elements selected from the group consisting of Co, Ni and M.

From the viewpoint of suppressing development of an α-(Fe, Co, Ni, M) phase and its nitride phase during production of the magnetic material of the present disclosure, the overall composition (the sum of the main phase and the phase other than the main phase) of the magnetic material of the present disclosure can be set to be equal to or larger than the total number of moles of Sm, La, Ce and R of the main phase. That is, the overall composition of the magnetic material of the present disclosure may be (Sm_{(1-x-y-z)}LaₓCe_{y}R¹_{z})_{w}(Fe_{(1-p-q-s)}CoₚNi_{q}Mₛ)₁₇Nₕ (where w is from 2.00 to 3.00). At this time, x, y, z, p, q, s and h may be the same as x, y, z, p, q, s and h in the above-described formula representing the composition of the main phase. From the viewpoint of suppressing development of an α-(Fe, Co, Ni, M) phase, w is preferably 2.02 or more, 2.04 or more, 2.06 or more, 2.08 or more, 2.10 or more, 2.20 or more, 2.30 or more, 2.40 or more, or 2.50 or more. On the other hand, from the viewpoint of decreasing the volume fraction of the above-described (Sm, La, Ce, R¹)(Fe, Co, Ni, M)₃ phase, w is preferably 2.90 or less, 2.80 or less, 2.70 or less, or 2.60 or less.

### <Density of Main Phase>

As long as the main phase of the magnetic material of the present disclosure has the hereinbefore-described crystal structure and composition, the density of the main phase is not particularly limited. The density of the main phase may be, for example, 7.38 g/cm³ or more, 7.40 g/cm³ or more, 7.42 g/cm³ or more, 7.44 g/cm³ or more, 7.46 g/cm³ or more, 7.48 g/cm³ or more, or 7.50 g/cm³ or more, and may be 8.80 g/cm³ or less, 8.60 g/cm³ or less, 8.40 g/cm³ or less, 8.20 g/cm³ or less, 8.00 g/cm³ or less, 7.80 g/cm³ or less, or 7.60 g/cm³ or less.

The density of the main phase is determined by pulverizing the magnetic material of the present disclosure to obtain powder and measuring the density of the powder by a pycnometer method. As described above, in the magnetic material of the present disclosure, the volume fraction of the main phase is preferably 80% or more. Also, the densities of the Sm₂Fe₁₇N₃ phase and the SmFe₃ phase are 7.65 g/cm³ and 8.25 g/cm³, respectively, and are not so different. Therefore, the density of the main phase can be approximated by the value obtained by the measurement method above.

### <<Production Method>>

Next, the production method of the Sm—Fe—N-based magnetic material of the present disclosure (hereinafter, sometimes referred to as the “production method of the present disclosure”) is described.

The production method of the present disclosure includes a magnetic material precursor preparation step and a nitriding step. In the following, each step is described.

### <Magnetic Material Precursor Preparation Step>

In the production method of the present disclosure, a magnetic material precursor including a crystal phase having a composition represented by the molar ratio formula (Sm_{(1-x-y-z)}LaₓCe_{y}R¹_{z})₂(Fe_{(1-p-q-s)}CoₚNi_{q}Mₛ)₁₇ is prepared.

In the formula representing the composition of the crystal phase, Sm, La, Ce, R¹, Fe, Co, Ni, M, x, y, z, p, q and s are as described in “<<Magnetic Material>>”.

The crystal phase of the magnetic material precursor has a crystal structure of at least either Th₂Zn₁₇ type or Th₂Ni₁₇ type. When the magnetic material precursor is nitrided, the crystal phase in the magnetic material precursor is nitrided to form the main phase of the magnetic material of the present disclosure. The main phase of the Sm—Fe—N-based magnetic material of the present disclosure has a crystal structure of at least either Th₂Zn₁₇ type or Th₂Ni₁₇ type. Therefore, nitriding is performed to such an extent as to maintain the crystal structure of at least either Th₂Zn₁₇ type or Th₂Ni₁₇ type.

As described above, since the main phase of the magnetic material of the present disclosure is formed as a result of nitriding of the crystal phase in the magnetic material precursor, the volume fraction of the crystal phase in the magnetic material precursor may be considered to be equivalent to the volume fraction of the main phase in the magnetic material of the present disclosure. Therefore, the volume fraction of the crystal phase of the magnetic material precursor may be, relative to the entire magnetic material precursor, 80% or more, 85% or more, or 90% or more. The production of the magnetic material precursor sometimes, for example, involves a step of entering a temperature range where a phase other than the crystal phase represented by the composition formula above is stable. Also, it is sometimes difficult to be completely free from unavoidable impurity elements not constituting the crystal phase. Although the volume fraction of the crystal phase is ideally 100%, as long as the above-described volume fraction of the crystal phase is ensured, there is no problem in practical use even when the volume fraction of the main phase is 99% or less, 97% or less, or 95% or less. The method for calculating the volume fraction of the main phase is as described above.

The phase other than the crystal phase is typically present at grain boundaries between crystal phases, particularly at a triple point. The phase other than the crystal phase typically includes a SmFe₃ phase, etc. The SmFe₃ phase includes a phase in which part of Sm is substituted by one or more elements selected from the group consisting of La, Ce and R¹, a phase in which part of Fe is substituted by one or more elements selected from the group consisting of Co, Ni and M, and a phase in which part of Sm is substituted by one or more elements selected from the group consisting of La, Ce and R¹ and part of Fe is substituted by one or more elements selected from the group consisting of Co, Ni and M.

From the viewpoint of suppressing development of an α-(Fe, Co, Ni, M) phase during production of the magnetic material precursor, the overall composition (the sum of the crystal phase and the phase other than the crystal phase) of the magnetic material precursor can be set to be equal to or larger than the total number of moles of Sm, La, Ce and R of the crystal phase. That is, the overall composition of the magnetic material precursor may be (Sm_{(1-x-y-z)}LaₓCe_{y}R¹_{z})_{w}(Fe_{(1-p-q-s)}CoₚNi_{q}Mₛ)₁₇ (where w is from 2.00 to 3.00). At this time, x, y, z, p, q and s may be the same as x, y, z, p, q and s in the above-described formula representing the composition of the main phase. From the viewpoint of suppressing development of an α-(Fe, Co, Ni, M) phase, w is preferably 2.02 or more, 2.04 or more, 2.06 or more, 2.08 or more, 2.10 or more, 2.20 or more, 2.30 or more, 2.40 or more, or 2.50 or more. On the other hand, from the viewpoint of decreasing the volume fraction of the (Sm, La, Ce, R¹)(Fe, Co, Ni, M)₃ phase, w is preferably 2.90 or less, 2.80 or less, 2.70 or less, or 2.60 or less.

The magnetic material precursor can be obtained using a well-known production method. The method for obtaining the magnetic material precursor includes, for example, a method in which raw materials containing elements constituting the magnetic material precursor are melted and solidified. The method for preparing the raw materials includes, for example, a method in which the raw materials are charged into a container such as crucible and after obtaining a molten metal by subjecting the raw materials to arc-melting or high-frequency melting in the container, the molten metal is poured into a mold such as book mold or the molten metal is solidified in the crucible. From the viewpoint of, e.g., suppressing coarsening of the crystal phase in the magnetic material precursor and homogenizing the crystal phase, it is preferable to increase the cooling rate of the molten metal. From this viewpoint, it is preferable to pour the molten metal into a mold such as book mold. Furthermore, from the viewpoint of, e.g., suppressing the coarsening of the crystal phase in the magnetic material precursor and homogenizing the crystal phase, for example, the following method may be employed. That is, an ingot obtained by subjecting the raw materials to high-frequency melting or arc-melting and solidification in a container is again melted by high-frequency melting, etc., the melt is quenched using a strip casting method, a liquid quenching method, etc. to obtain a flake, and the flake may be used as the magnetic material precursor.

Prior to the below-described nitriding, the magnetic material precursor may be subjected to a heat treatment so as to homogenize crystal grains in the magnetic material precursor (hereinafter, such a heat treatment is sometimes referred to as “homogenization heat treatment”). The temperature of the homogenization heat treatment may be, for example, 1273 K or more, 1323 K or more, or 1373 K or more and may be 1523 K or less, 1473 K or less, or 1423 K or less. The homogenization heat treatment time may be, for example, 6 hours or more, 12 hours or more, 18 hours or more, or 24 hours or more and may be 48 hours or less, 42 hours or less, 36 hours or less, or 30 hours or less.

In order to suppress oxidation of the magnetic material precursor, the homogenization heat treatment is preferably performed in an inert gas atmosphere. A nitrogen gas atmosphere is not encompassed by the inert gas atmosphere. This is because if the homogenization heat treatment is performed in a nitrogen gas atmosphere, the phase having Th₂Zn₁₇ type and/or Th₂Ni₁₇ type crystal structures is likely to decompose.

### <Nitriding Step>

The above-described magnetic material precursor is nitrided. The crystal phase in the magnetic material precursor is thereby nitrided to form the main phase of the magnetic material of the present disclosure.

The nitriding method is not particularly limited as long as a desired main phase can be obtained but, typically, includes, for example, a method in which the magnetic material precursor is exposed, while being heated, to an atmosphere containing nitrogen gas or to a gas atmosphere containing nitrogen (N). The atmosphere containing nitrogen gas includes, for example, a nitrogen gas atmosphere, a mixed gas atmosphere of nitrogen gas and inert gas, and a mixed gas atmosphere of nitrogen gas and hydrogen gas. The gas atmosphere containing nitrogen (N) includes, for example, an ammonia gas atmosphere and a mixed gas atmosphere of ammonia gas and hydrogen gas. The atmospheres exemplified above may be combined. In view of nitriding efficiency, an ammonia gas atmosphere, a mixed gas atmosphere of ammonia gas and hydrogen gas, and a mixed gas atmosphere of nitrogen gas and hydrogen gas are preferred.

After a magnetic material precursor powder is obtained by pulverizing the magnetic material precursor before nitriding, the magnetic material precursor powder may be nitrided. By pulverizing and then nitriding the magnetic material precursor, the crystal phase present inside the magnetic material precursor can be sufficiently nitrided. The pulverization of the magnetic material precursor is preferably performed in an inert gas atmosphere. The inert gas atmosphere may include a nitrogen gas atmosphere. This makes it possible to prevent oxidation of the magnetic material precursor from occurring during pulverization. The particle size of the magnetic material precursor powder may be, in terms of D₅₀, 5 μm or more, 10 μm or more, or 15 μm or more and may be 50 μm or less, 40 μm or less, 30 μm or less, 25 μm or less, or 20 μm or less.

The nitriding temperature may be, for example, 673 K or more, 698 K or more, 723 K or more, or 748 K or more and may be 823 K or less, 798 K or less, or 773 K or less. Also, the nitriding time may be, for example, 4 hours or more, 8 hours or more, 12 hours or more, or 16 hours or more and may be 48 hours or less, 36 hours or less, 24 hours or less, 20 hours or less, or 18 hours or less.

### Modification

The magnetic material of the present disclosure and the production method thereof are not limited to the embodiments described so far and may be appropriately modified within the scope of the claims. For example, the magnetic material of the present disclosure may be a powder or may be a molded body of the powder. The molded body may be a bonded molded body or may be a sintered molded body. In the case of a molded body, a bonded molded body is preferred for the reason that it is easy to avoid such temperatures as to cause nitrogen (N) in the main phase to desorb (decompose) during the molding step. The bond includes, for example, a resin and a low melting point metal bond. The low melting point metal bond includes, for example, zinc metal, a zinc alloy, and a combination thereof. In the case of using a low melting point metal bond, pressure sintering may be performed at such a low temperature as not to cause desorption (decomposition) of nitrogen (N) in the main phase.

### Examples

The magnetic material of the present disclosure and the production method thereof are described more specifically below with reference to Examples and Comparative Examples. Note that the magnetic material of the present disclosure and the production method thereof are not limited to the conditions used in the following Examples.

### Preparation of Sample

Samples of the Sm—Fe—N-based magnetic material were prepared in the following manner.

Sm metal, La metal, Ce—Fe alloy, Fe metal, Co metal and Ni metal were mixed so that the main phase may have the composition shown in Table 1, and the mixture was subjected to high-frequency melting at 1673 K (1,400° C.) and solidified to obtain a magnetic material precursor. At the time of mixing, the total number of moles of mixed Sm, La, and Ce was set larger than the total number of moles of Sm, La, and Ce in the main phase so that the volume fraction of the main phase can be from 95 to 100%. Here, in the present description, for example, “Sm metal” means Sm that is not alloyed. Needless to say, Sm metal may contain an unavoidable impurity.

The magnetic material precursor was subjected to a homogenization heat treatment in an argon gas atmosphere at 1373 K over 24 hours.

The magnetic material precursor after the homogenization heat treatment was charged into a glove box, and the magnetic material precursor was pulverized by means of a cutter mill in a nitrogen gas atmosphere. The particle size of the magnetic material precursor powder after the pulverization was 20 μm or less in terms of D₅₀.

In a nitrogen gas atmosphere, the magnetic material precursor powder was heated to 748 K and nitrided over 16 hours. The nitriding amount was recognized by a change in mass of the magnetic material precursor powder before and after nitriding.

### Evaluation

The volume fraction and density of the main phase were determined for each sample by the above-described measurement methods. Also, the magnetic properties of each sample were measured by applying a maximum magnetic field of 9 T using a Physical Properties Measurement System PPMS (registered trademark)-VSM. With respect to the measurement of the magnetic properties, each sample powder after nitriding was solidified while being magnetically oriented in an epoxy resin, and the magnetic properties of each sample after solidification were measured at 300 K in a magnetization easy axis direction and a magnetization hard axis direction. From the measured values in the magnetization easy axis direction, a saturation magnetization Ms was calculated using the law of approach to saturation.

The results are shown in Tables 1-1 and 1-2. In Table 1-2, regarding A to C of “Stability of Main Phase”, A means “Good”, B means “Relatively Good”, and C means “Poor (the crystal structure of the main phase is broken)”. In addition, as described above, the molar ratios of three elements Sm, La and Ce in Examples 1 to 6 and Comparative Examples 1 to 11 of Tables 1-1 and 1-2 are plotted in FIGS. 1 and 2.

TABLE 1-1

| | Composition of Main Phase | | | | | | | | |
|---|---|---|---|---|---|---|---|---|---|
| | | Molar Ratio of Rare Earth | | | Molar Ratio of Transition | | | | |
| | | Element | | | Metal Element | | | | |
| | | Sm | La | Ce | Fe | Co | Ni | | |
| | Molar Ratio Formula | (1-x-y) | (x) | (y) | (1-p-q) | (p) | (q) | x + y | p + q |
| Example 1 | (Sm0.49La0.17Ce0.34)2(Fe0.98N10.02)17N3 | 0.49 | 0.17 | 0.34 | 0.98 | 0 | 0.02 | 0.51 | 0.02 |
| Example 2 | (Sm0.44Ce0.4La0.16)2Fe17N3 | 0.44 | 0.16 | 0.40 | 1.00 | 0 | 0 | 0.56 | 0 |
| Example 3 | (Sm0.49La0.27Ce0.24)2(Fe0.98Ni0.02)17N3 | 0.49 | 0.27 | 0.24 | 0.98 | 0 | 0.02 | 0.51 | 0.02 |
| Example 4 | (Sm0.25Ce0.45La0.31)2Fe17N3 | 0.25 | 0.31 | 0.45 | 1.00 | 0 | 0 | 0.75 | 0 |
| Example 5 | (Sm0.31La0.09Ce0.6)2Fe17N3 | 0.31 | 0.09 | 0.60 | 1.00 | 0 | 0 | 0.69 | 0 |
| Example 6 | (Sm0.36La0.14Ce0.5)2Fe17N3 | 0.36 | 0.14 | 0.50 | 1.00 | 0 | 0 | 0.64 | 0 |
| Comparative Example 1 | (Sm0.2Ce0.65La0.16)2Fe17N3 | 0.20 | 0.16 | 0.65 | 1.00 | 0 | 0 | 0.80 | 0 |
| Comparative Example 2 | (Sm0.53La0.14Ce0.34)2Fe17N3 | 0.53 | 0.14 | 0.34 | 1.00 | 0 | 0 | 0.47 | 0 |
| Comparative Example 3 | (Sm0.5Ce0.5)2Fe17N3 | 0.50 | 0.00 | 0.50 | 1.00 | 0 | 0 | 0.50 | 0 |
| Comparative Example 4 | (Sm0.79Ce0.21)2Fe17N3 | 0.79 | 0.00 | 0.21 | 1.00 | 0 | 0 | 0.21 | 0 |
| Comparative Example 5 | Sm2Fe17N3 | 1.00 | 0.00 | 0.00 | 1.00 | 0 | 0 | 0.00 | 0 |
| Comparative Example 6 | (Sm0.4Ce0.6)2Fe17N3 | 0.40 | 0.00 | 0.60 | 1.00 | 0 | 0 | 0.60 | 0 |
| Comparative Example 7 | (Ce0.82La0.18)2Fe17N3 | 0 | 0.18 | 0.82 | 1.00 | 0 | 0 | 1.00 | 0 |
| Comparative Example 8 | (Ce0.61La0.39)2Fe17N3 | 0 | 0.39 | 0.61 | 1.00 | 0 | 0 | 1.00 | 0 |
| Comparative Example 9 | Ce2Fe17N3 | 0 | 0.00 | 1.00 | 1.00 | 0 | 0 | 1.00 | 0 |
| Comparative Example 10 | (Sm0.71La0.3)2Fe17N3 | 0.70 | 0.30 | 0.00 | 1.00 | 0 | 0 | 0.30 | 0 |
| Comparative Example 11 | (Sm0.5La0.5)2Fe17N3 | 0.50 | 0.50 | 0.00 | 1.00 | 0 | 0 | 0.50 | 0 |

TABLE 1-2

| | | | | | | | | | Percentage | | Saturation |
|---|---|---|---|---|---|---|---|---|---|---|---|
| | Composition of Main Phase | | | | | | | Stability | of Main | | Magnetization |
| | Content Ratio of Constiment Element (at %) | | | | | | | of Main | Phase | Density | Ms at 300K |
| | Sm | La | Ce | Fe | Co | Ni | N | Phase | (%) | (g/cm³) | (T) |
| Example 1 | 4.45 | 1.55 | 3.09 | 75.49 | 0 | 1.78 | 13.64 | A | 89.0 | 7.466 | 1.539 |
| Example 2 | 3.99 | 1.44 | 3.66 | 77.27 | 0 | 0 | 13.64 | A | 92.2 | 7.416 | 1.551 |
| Example 3 | 4.45 | 2.45 | 2.18 | 75.35 | 0 | 1.92 | 13.64 | A-B | 81.5 | 7.543 | 1.656 |
| Example 4 | 2.23 | 2.78 | 4.08 | 77.27 | 0 | 0 | 13.64 | A-B | 90.0 | 7.549 | 1.518 |
| Example 5 | 2.82 | 0.79 | 5.48 | 77.27 | 0 | 0 | 13.64 | A | 93.9 | 8.746 | 1.572 |
| Example 6 | 3.24 | 1.28 | 4.57 | 77.27 | 0 | 0 | 13.64 | A | 93.4 | 8.750 | 1.519 |
| Comparative Example 1 | 1.80 | 1.42 | 5.87 | 77.27 | 0 | 0 | 13.64 | A-B | 90.0 | 7.571 | 1.457 |
| Comparative Example 2 | 4.80 | 1.24 | 3.06 | 77.27 | 0 | 0 | 13.64 | A | 98.2 | 7.454 | 1.456 |
| Comparative Example 3 | 4.59 | 0 | 4.50 | 77.27 | 0 | 0 | 13.64 | A | 99.4 | 7.541 | 1.499 |
| Comparative Example 4 | 7.21 | 0 | 1.88 | 77.27 | 0 | 0 | 13.64 | A | 99.3 | 7.821 | 1.549 |
| Comparative Example 5 | 9.09 | 0 | 0.00 | 77.27 | 0 | 0 | 13.64 | A | 97.8 | 7.584 | 1.504 |
| Comparative Example 6 | 3.61 | 0 | 5.48 | 77.27 | 0 | 0 | 13.64 | A | 98.9 | 7.374 | 1.440 |
| Comparative Example 7 | 0.00 | 1.64 | 7.45 | 77.27 | 0 | 0 | 13.64 | A | — | — | — |
| Comparative Example 8 | 0.00 | 3.51 | 5.58 | 77.27 | 0 | 0 | 13.64 | C | — | — | — |
| Comparative Example 9 | 0.00 | 0 | 9.09 | 77.27 | 0 | 0 | 13.64 | C | — | — | — |
| Comparative Example 10 | 6.36 | 2.73 | 0 | 77.27 | 0 | 0 | 13.64 | C | — | — | — |
| Comparative Example 11 | 4.55 | 4.55 | 0 | 77.27 | 0 | 0 | 13.64 | C | — | — | — |

It can be understood from Tables 1-1 and 1-2 and FIGS. 1 and 2 that in the samples of Examples 1 to 6, even when the total substitution amount of La and Ce is 0.51 or more by molar ratio, the saturation magnetization is higher than when Sm is not substituted by La and Ce (Comparative Example 5). This leads to an understanding that the use amount of Sm is more reduced than ever before while enhancing the saturation magnetization.

These results can confirm the effects of the magnetic material of the present disclosure and the production method thereof.

1. A Sm—Fe—N-based magnetic material comprising a main phase having a crystal structure of at least either Th₂Zn₁₇ type or Th₂Ni₁₇ type, wherein
the main phase is represented by the molar ratio formula (Sm_{(1-x-y-z)}LaₓCe_{y}R¹_{z})₂(Fe_{(1-p-q-s)}CoₚNi_{q}Mₛ)₁₇Nₕ, where R¹ is one or more rare earth elements other than Sm, La and Ce, and Zr, and M is one or more elements other than Fe, Co, Ni and rare earth elements, and an unavoidable impurity element, and
$$0.09 \leq x \leq 0.31 , \\ 0.24 \leq y \leq 0.6 , \\ 0.51 \leq x + y \leq 0.75 , \\ 0 \leq z \leq 0.1 , \\ 0 \leq p + q \leq 0.1 , \\ 0 \leq s \leq 0.1 , and \\ 2.9 \leq h \leq 3.1 are satisfied .$$

2. The Sm—Fe—N-based magnetic material according to claim 1, wherein x and y satisfy 0.16≤x≤0.31 and 0.24≤y≤0.45.

3. The Sm—Fe—N-based magnetic material according to claim 1, wherein the volume fraction of the main phase is 80% or more and 100% or less.

4. A production method of the Sm—Fe—N-based magnetic material according to claim 1, the Sm—Fe—N-based magnetic material production method comprising:
preparing a magnetic material precursor including a crystal phase having a composition represented by the molar ratio formula (Sm_{(1-x-y-z)}LaₓCe_{y}R¹_{z})₂(Fe_{(1-p-q-s)}CoₚNi_{q}Mₛ)₁₇, where R¹ is one or more rare earth elements other than Sm, La and Ce, and Zr, and M is one or more elements other than Fe, Co, Ni and rare earth elements, and an unavoidable impurity element, in which 0.09≤x≤0.31, 0.24≤y≤0.60, 0.51≤x+y≤0.75, 0≤z≤0.10, 0≤p+q≤0.10, and 0≤s≤0.10 are satisfied, and
nitriding the magnetic material precursor.

5. The Sm—Fe—N-based magnetic material production method according to claim 4, wherein x and y satisfy 0.16≤x≤0.31 and 0.24≤y≤0.45.
